(19) United States
(12) Patent Application Publication
(10) Pub. No.: US 2025/0292924 A1
(43) Pub. Date: Sep. 18, 2025

(54) METHOD FOR REFURBISHING A NUCLEAR POWER PLANT INITIALLY COMPRISING AT LEAST ONE LIGHT-WATER NUCLEAR REACTOR (LWR), IN PARTICULAR A PRESSURISED WATER REACTOR (PWR) OR A BOILING WATER REACTOR (BWR), WITH AT LEAST ONE INTEGRATED MODULAR NUCLEAR REACTOR (SMR)

(71) Applicant: COMMISSARIAT A L'ENERGIE ATOMIQUE ET AUX ENERGIES ALTERNATIVES, Paris (FR)

(72) Inventor: Philippe AMPHOUX, Aix En Provence (FR)

(21) Appl. No.: 18/860,174

(22) PCT Filed: May 31, 2023
(86) PCT No.: PCT/EP2023/064512

§ 371 Date: Oct. 25, 2024

(30) Foreign Application Priority Data
May 31, 2022 (FR) FR2205196

(51) Int. Cl. G21D 1/00; G21C 1/08; G21C 1/32; G21C 13/067; G21C 21/00; G21F 9/00

(52) U.S. Cl. CPC G21D 1/003; G21C 1/32; G21C 13/0675; G21C 21/00; G21F 9/001; G21C 1/084; G21C 1/086

(57) ABSTRACT

A method for retrofitting a nuclear power plant which include dismantling and removing all the components of the primary circuit apart from the LWR reactor vessel, which is essentially emptied of all material and neutralized, subsequently replacing a part of these components with subassemblies that are each made up of an integrated SMR reactor and a mixed concrete/metal structure, which mixed concrete/metal structure is also used as a reactor pit for the SMR reactor, which reactor pit is advantageously filled with water, anchoring the SMR to the inside of the reactor building and advantageously contributing to the third confinement barrier while ensuring minimal disruption to the infrastructure of the reactor building.

### TECHNICAL FIELD

The present invention concerns the field of nuclear power plants, in particular the installed base of nuclear power plants comprising light-water nuclear reactors (LWR), in particular pressurized water and boiling water nuclear reactors.

Thus an objective of the invention is to alleviate a major drawback of cost and capacity for refurbishing the installed base of LWR reactor nuclear power plants.

Although described with reference to a nuclear power plant comprising at least one pressurized water nuclear reactor, the invention applies to any boiling water nuclear reactor nuclear power plant or more generally to any light water nuclear reactor (LWR) nuclear power plant.

### PRIOR ART

A large portion of the current installed base of pressurized water reactor (PWR) nuclear power plants is soon arriving at the end of its operating life for which reactors were designed and licensed, in a context in which the energy transition with decarbonization of uses will increase the demand for electricity (competitive, highly available and non-intermittent electricity).

FIG. 1, extracted from publication [1], traces the chronology of commissioning reactors on the worldwide scale. Most of the 440 reactors that constitute the worldwide installed base were commissioned in the decades 1970 to 1990.

With a programmed operating life of 40 to 60 years, depending on the country, authorization rules or extension of operation rules, all these reactors will be shut down at the latest between the decades 2030 and 2050. Countries employing a nuclear installed base for their electrical energy supply and wishing to maintain that installed base will therefore have to face up to a high investment.

PWR rectors represent more than 60% of the 440 reactors in the worldwide nuclear installed base.

A pressurized water nuclear reactor (PWR) comprises three cycles (fluid circuits) the general principle of normal operation of which is as follows.

Water at high pressure in a primary circuit picks up the energy supplied in the form of heat by the fission of uranium nuclei, and where appropriate plutonium nuclei, in the core of the reactor.

This water at high pressure and high temperature, typically at 155 bar and 300° C., then enters a steam generator (SG) and transmits its energy to a secondary circuit, that circuit also using water under pressure as the heat-transfer fluid. This water in steam form at high pressure, typically at around 70 bar, is then expanded via an expansion member transforming the variation of the enthalpy of the fluid into mechanical work and then into electricity in an electric generator.

The water in the secondary circuit is then condensed via a condenser using a third cycle, the cooling cycle, as the cold source.

The design principles of PWR reactors in these three cycles have been substantially the same since the beginning of commissioning the first ones used.

The main elements of a PWR primary circuit are shown in FIGS. 2A to 2C:
a reactor building 1 with various functions including in particular a contribution to the confinement safety function,
a reactor vessel 20, installed at the center of the building 1, accommodating the core C of the reactor,
a primary pressurized water circuit 2 including the reactor vessel 20.

These main elements are therefore shared, their composition and the number of components varying according to the power of the reactor.

The casing of the reactor building 1 can typically consist of a plurality of thicknesses.

Accordingly, depending on the configuration, a reactor building 1 may consist of:
a prestressed concrete wall 10 serving as an interface with the exterior, the interior of which is coated with a metal skin 11 with a confinement sealing function in a 900 MWe reactor (FIG. 2A);
a reinforced concrete exterior wall 12 and a prestressed concrete interior wall 10 separated from the exterior wall 12 by an annular space 13 in which there is no material in a 1300/1450 Mwe reactor (FIG. 2B);
a reinforced concrete exterior wall 12, a prestressed concrete interior wall 10 separated from the exterior wall 12 by an annular space 13 in which there is no material and a metal skin 11 on the interior of the prestressed concrete wall 10 in a 1650 MWe reactor (FIG. 2C).

As depicted in FIG. 3, taken from publication [2], the primary circuit 2 consists of the following main components:
a reactor vessel 20,
primary loops 21 each comprising a primary pump 22 and a steam generator 23,
a single pressurizer 24.

Also seen in FIG. 3 are the control rod mechanisms of the reactor core and control rods 25.

Depending on the power of the reactor, the number of loops may be three in a 900 MWe reactor (FIG. 3) or 4 in a 1300 MWe and above reactor.

The reactor building 1 is therefore sized, among other things, to accommodate all of the components of the primary circuit 2.

FIG. 4 depicts the energy transfer cycle (heat then electricity) of a PWR reactor. In this FIG. 4 there can be seen in particular the distribution of the positions of the components relative to the reactor building 1, which has a third confinement barrier function.

The fluid connections between the interior and the exterior of the reactor building 1 are provided by the lines 30, 31 of the external circuit of the steam generators 23 leading to the secondary circuit 3 comprising a turbine 32 connected to the electric generator 33, a condenser 34, a feed pump 35 and a heater that is not represented.

To be more precise, for a given steam generator 23 the reactor building 1 has passed through it a so-called hot line 30 that evacuates the steam from the steam generator 23 for the evacuation of power and feeds it to a turbine 32 and a so-called cold line 31 that feeds the steam generator 23 with liquid water.

At present all existing PWR reactor technologies are based on the principle of a power plant the operating life of which is dependent on the operating life of the non-replaceable component or components that has (have) the shortest operating life.

These are mainly components of the primary circuit and critically the reactor vessel, which are the components that dictate the operating life of the power plant, because of the consequences of activation of materials and of ageing of some of them.

It is therefore mainly the age of the reactor vessel that is going to dictate the operating life of the power plant overall and that initially leads to predicting operation of existing power plants over a period of 40 to 60 years, depending on the country and in particular on the reassessment of safety.

The other structural elements of the reactors also age. Of these, two classes can be distinguished: elements that are replaceable and elements that are not replaceable during the operating life.

The replaceable elements include the steam generators, the primary pumps and the pressurizer.

Beyond the primary circuit referred to hereinabove, the non-replaceable elements include in particular the civil engineering structures ageing of which has to be analyzed as a function of the safety requirements that are assigned to them. For a PWR reactor with lines of the primary circuit that operate with pressurized water and are arranged overhead, an accident in the primary circuit requires particular sizing of the reactor building that has to provide the function of safe confinement of the nuclear materials. There may be cited in particular the Loss of Primary Refrigerant Accident studied in reports on the safety of pressurized water reactors (PWR) that is a hypothetical accident caused by a breach in the casing of the primary circuit. There is therefore a direct link between the operating life of the concrete structure of the building and the safety functions that are assigned to it.

A technology that is emerging at this time is that of small modular reactors (SMR). These SMR reactors have primordial advantages over existing PWR of enabling simplification of systems, principally for safety reasons, and increased modularity by manufacturing many components in off-site plant for transportation to the construction site.

SMR are also flexible because of their low power level and their territorial insertion capability.

There would therefore appear to be a competitive future solution. At this writing approximately 70 SMR projects have been identified worldwide at more or less advanced stages, a quarter of which use mature, third generation (Gen-III) technology such as that of the French installed base.

Some of the SMR under development propose a configuration based on integration of the steam generator, or even of all the components of the primary circuit, in particular the pressurizer and the primary pumps, inside the reactor vessel. These SMR are termed integrated SMR. Apart from the improvement in compactness, integrated SMR have the advantage of no longer necessitating overhead pressurized water fluid lines, which considerably reduces the risks of accidents and consequences associated therewith linked to the rupture of the lines of the primary circuit.

For example, the NUWARD™ nuclear power plant project is a power plant consisting of two integrated SMR each with a power rating of 170 MWe, with all the components of the primary circuit 1 inside the reactor vessel.

Other integrated SMR projects are under development or have been studied, among which there may be cited the SCOR project with a power rating of 150 to 200 MWe in the name of the Applicant and the ACP100 project with a power rating equal to 100 MWe.

The increased compactness of an integrated SMR complicates its operation compared to a standard PWR.

In fact, the main operations of operability and structural maintainability of the architecture for a reactor primary circuit are as follows:
operations of loading/offloading the fuel that necessitate access to the interior of the reactor vessel under appropriate radioprotection conditions,
operations for maintenance of the equipment that necessitate access to the equipment.

Referring to FIG. 3, it is seen that the loops of a primary circuit 2 of a standard PWR are designed to allow maintenance of each component without impacting at all or to an extremely limited extent the other components and that the fuel handling operations are effected by opening the lid of the reactor vessel 20 without impacting the primary loops 21.

On the other hand, because of the integration of the components, in an integrated SMR access to the fuel zone for loading/offloading operations can require demounting of functional parts of the primary circuit, which is more of a task than handling the lid of the reactor vessel. In integrated SMR designs accessibility to some components differs depending on their configuration and because of the positioning of the components and their functional assembly. For example, in some SMR reactor designs the operations of loading the fuel may necessitate removing some components of the primary circuit.

Likewise, in some SMR reactor designs the positioning of the inlet/outlet tappings of the steam and feed water top-up lines can vary between the lower compartment that is fixed and the upper compartment, which is removable in an SMR reactor. In the case of an arrangement of the tappings on the removable upper compartment, the operations of handling the fuel require disconnection beforehand of the steam and water top-up lines at the inlet of the steam generator.

These configuration differences depending on the design are mainly linked:
to the choice of technologies of the internal components, in particular the type of exchanger, pressurizer, pumps, . . . ,
to principles of arrangement and re-assembly of the architecture internal to the reactor vessel (position and type of steam generator), particularly re-assembly of so-called critical paths. For example, in the SCOR project the steam generators are on the vertical critical path.

To summarize, the principal structural design criteria of an integrated SMR reactor with a view to its architectural integration in a reactor building are:
the requirement for vertical and/or axial accessibility for handling fuel and maintenance of components,
the methodologies of removing/replacing upper functional parts positioned in the removable compartment of the SMR in order to access the fuels,
the positioning of the tappings of the steam and/or feed water fluid connections in the removable compartment.

At the end of the programmed operating life of pressurized water reactor (PWR) nuclear power plants they must be dismantled.

In France, at this writing, no PWR reactor power plant has yet been dismantled. Worldwide, the number of PWR reactor power plants dismantled is extremely limited.

Nevertheless, a first power plant was shut down in 2021 in France, namely the Fessenheim power plant, and dismantling it is about to be initiated. The company EDF, the operator of this nuclear power plant, has drawn up a dismantling plan: [2]. See in particular the page of that plan on the chronology of the various stages envisaged, before, during and after dismantling.

Prior to dismantling proper, operations of shutting down processes and regularizing the power plant will have to be carried out. These preparation for dismantling operations are aimed at:
reducing the risks and disadvantages of the installation: evacuation of spent and new fuels, waste and effluents, draining of circuits, decontamination of certain circuits; at this writing 99.9% of the radioactivity has been evacuated,
preparing the power plant for the dismantling operations: organization of access and pathways, adaptation of support functions, in particular ventilation, electrical power distribution and handling, evacuation of certain equipment to free up space;
refining the knowledge of the state of the installation: inventory of hazardous materials, identification of asbestos, taking samples for radiological analysis. The intended final state on completion of dismantling is a non-nuclear site in which all buildings have been demolished to a depth of one meter below ground level.

There have been reproduced in FIGS. 5A to 5D the four successive steps of the dismantling process as envisaged in the plan [3] and depicted on page 5 of that plan.

Step 1: this is electromechanical dismantling, which consists in removing and cutting up all the equipment/components present in particular in the reactor building 1, in particular those of the primary loops 21 (reactor vessel 20, pumps 22, steam generators 23, . . . ) and packaging same as waste, that will be monetized where possible (FIG. 5A). Only the equipment necessary for carrying out the decontamination works in step 2 are left in place.

Step 2: decontamination of the structures of the nuclear buildings consists in eliminating radioactive contamination deposited inside the buildings, in particular on the interior wall of the reactor building 1 and the infrastructure 4 within it (FIG. 5B).

Step 3: demolition of the buildings including the reactor building 1 and the machine room 5. For conventional buildings demolition may take place as soon as they are no longer of any utility for dismantling. For the nuclear buildings it cannot commence until the structures have been decontaminated in step 2. The cavities below ground level are filled in with backfill, consisting of rubble produced by the demolition (FIG. 5C).

Step 4: rehabilitation of the site. It consists ensuring the compatibility between the state of the ground and future use. Any zones in which the buried part 40 of the initial infrastructure 4 are chemically or radiologically marked are the subject of a soil management plan (FIG. 5D).

Most of the electronuclear installed base comes to the end of operation in the next two decades, in the context of an increase in the demand for electricity because of the electrification of a large number of energy uses resulting from the decarbonization of our energy.

Nuclear power plants therefore have been or will be shut down although their operating life will not have paid back a major part of the investment initially made, leaving nuclear operators faced with high investment for renewal of some or all of the nuclear power plant installed base.

The authors of publication [5] consider the relevance of a power plant design based on Pb—Bi FNR type reactor technology in the form of reactor modules.

The authors of publication [6] mention the theoretical potential for insertion of a Pb—Bi SVBR 75/100 FNR reactor unit in a nuclear power plant containing light-water reactors in which the reactors have reached their end of life.

Publication [7] refers to the renovation of old NPP type power plants with Pb—Bi SVBR 75/100 FNR unitary blocks. The authors laconically and exclusively mention the economic aspects to be taken into account to carry out such renovation, which includes spatial insertion of reactor blocks in the original reactor building.

There therefore exists a need to find a solution that can make it possible to reduce the investment in light-water (LWR) nuclear reactor nuclear power plants, in particular of pressurized water (PWR) or boiling water (BWR) type, that is linked to shutting them down.

In particular to dismantling them as planned at present.

The objective of the invention is therefore to address this need at least in part.

### SUMMARY OF THE INVENTION

To this end, one aspect of the invention concerns a method of retrofitting, i.e. refurbishing, a nuclear power plant initially comprising at least one light-water nuclear reactor (LWR), in particular a pressurized water reactor (PWR) or a boiling water reactor (BWR).

One configuration of a pressurized water reactor (PWR) includes a reactor building housing a reactor vessel, a primary circuit and a reactor pool, a fuel building, a nuclear fuel handling system for feeding nuclear fuel assemblies from the fuel building to the reactor building, inside the reactor vessel, and vice versa, a machine room, a control room and a nuclear auxiliaries building, the method including the following steps for each reactor:
a/ shutting down the reactor including evacuation to the exterior of the reactor building of all the fuel assemblies present in the reactor vessel and complete draining of the primary circuit,
b/ partial electromechanical dismantling of the reactor including removal and evacuation to the exterior of the reactor building of the components of the primary circuit with the exception of the reactor vessel of the reactor left in place in the reactor building, the removal of all material from the interior of the nuclear reactor vessel followed by neutralization of the latter,
c/ installation instead and in place of some of the components of the primary circuit evacuated during step a/of at least one removably closed hybrid structure itself consisting of a metal double skin and concrete poured into the space between the two metal walls constituting the double skin,
d/ placing and retaining in the interior of each hybrid structure installed in step c/at least one nuclear reactor, termed an integrated small modular reactor (SMR), the integrated SMR reactor(s) being arranged in a position accessible by the fuel handling system.

In the context of the invention the expression “nuclear island” has the usual meaning of the technology, namely the combination of the nuclear boiler and the installations relating to the fuel, together with the equipment necessary for the operation and the safety of that combination.

The expression “reactor building” has the usual meaning, namely a building that contains the reactor proper and all the components of the pressurized primary circuit and some of the circuits for the operation and safety of the reactor.

The expression “fuel building” has the usual meaning, namely a building in which are installed in particular storage facilities (fuel assembly storage pools) and handling facilities for new fuel (awaiting loading into the reactor) and irradiated fuel (awaiting transfer to a processing plant).

The expression “nuclear auxiliaries building” has the usual meaning, namely a building that shelters the auxiliary circuits necessary for normal operation of the reactor.

The expression “conventional island” has the usual meaning, namely a combination of all the equipment that make it possible to transform the heat generated by nuclear fission in an electricity circuit and then to cool the circuits.

The expression “machine room” has the usual meaning, namely a building that houses the turbine generator unit, the role of which is to transform the steam produced in the nuclear island to electricity, and its auxiliaries.

By “neutralization of the reactor vessel” is meant the fact that the vessel is closed in a sealed and radio-protective manner in order to render the reactor permanently non-usable, remaining as it does in place in its original reactor vessel, with no fuel material inside it and filled with an inert fluid to preserve it.

One advantageous embodiment of the method includes after step d/a step e/of fluid and/or electrical connection of each reactor to the control room and to the machine room, placement of the auxiliary circuits, and fluid and/or electrical connection to the nuclear auxiliaries building.

In one advantageous embodiment installation in step c/and placement in step d/include respective passage of each hybrid structure in the form of prefabricated modules and each integrated SMR reactor via the same access airlock to the exterior from the reactor building by which the whole of each component is evacuated in step b/.

In one advantageous variant the removal and evacuation in step b/ include the following successive sub-steps:
b1/ removal of the primary lines arranged between steam generators and the reactor vessel,
b2/ removal and evacuation of the steam generators,
b3/ removal and evacuation of the primary pumps,
b4/ removal and evacuation of the pressurizer,
b5/ removal of the primary lines initially at the outlet of the steam generators as far as passing through the shell of the reactor building.

In another advantageous variant the neutralization of the reactor vessel in step b/includes the following successive sub-steps:
b6/ sealed blocking of the hydraulic connections of the reactor vessel,
b7/ closure of the reactor vessel by replacing its lid and if necessary fitting a radioprotection cover,
b8/ filling of the reactor vessel with water or inert gas by means of a connecting and level or pressure monitoring device.

Step b6/ preferably consists in placing a solid plug in each hydraulic connection followed by sealed welding of the plug, the welds preferably being verified by gamma graphics.

In another advantageous embodiment step b/ includes, after neutralization of the reactor vessel, a step of decontaminating the reactor building to eliminate any radioactive contamination deposited in the interior of said building.

In another advantageous variant step c/ includes cutting and evacuation of parts of the shells and/or the floors and if necessary the raft of the infrastructure of the reactor building that initially support the components of the primary circuit.

In another advantageous variant step c/ includes fixing each hybrid structure to the raft of the infrastructure of the reactor building, preferably by means of a fixing plate itself rigidly attached or fixed to one and/or the other of the metal walls of the double skin.

In another advantageous variant step c/ includes, after positioning the hybrid structure(s) on and where necessary fixing it or them to the raft, the following successive sub-steps:
cutting and evacuation of the shell part separating the reactor vessel well of the LWR reactor forming part of the reactor pool of each hybrid structure,
installing a horizontal connecting pipe between each hybrid structure and the reactor vessel well.

A variant of the method includes after placement and retention of the integrated SMR reactor in step d/ placement of at least one isolating valve on the pipe, preferably two isolating valves, one on the hybrid structure side and the other on the reactor vessel well side. The invention further has for object a nuclear power plant obtained by the retrofit method described above including:
a reactor building housing a neutralized LWR reactor vessel and a reactor tool,
a nuclear fuel handling system for feeding nuclear fuel assemblies from the fuel building to the reactor building, inside the reactor vessel, and vice versa,
at least one, preferably three or four, hybrid structure(s) arranged around the neutralized reactor vessel, each hybrid structure housing an integrated SMR reactor, a fuel building, each integrated SMR reactor being arranged in a position accessible by the fuel handling system. The definitive number of hybrid structures each housing an integrated SMR will depend in particular on the power adaptation that is required for the power plant that is the subject of the retrofit.

An advantageous embodiment of the power plant further includes a horizontal connecting pipe between each hybrid structure and the reactor vessel well and at least one isolating valve on the pipe, preferably two isolating valves, one on the hybrid structure side and the other on the reactor vessel well side, the fuel handling system including at least one device for tilting fuel assemblies from the horizontal to the vertical one by one to enable transfer thereof via the connecting pipe.

In an advantageous construction variant each hybrid structure includes a bottom configured to support an integrated SMR reactor.

Each hybrid structure is advantageously filled at least in part with water.

Each hybrid structure is advantageously configured to contain the fixed compartment of the SMR reactor and the removable compartment of the latter when it is removed from the fixed compartment.

In an advantageous variant each hybrid structure is provided with a removable lid contributing to the function of safe confinement of nuclear materials.

Thus the invention essentially consists in a method of retrofitting a nuclear power plant that consists in removing and evacuating all the components of the primary circuit with the exception of the LWR reactor vessel, which is emptied of all material and neutralized, and then replacing instead and in place of some of those components sub-assemblies each consisting of an integrated SMR reactor and a hybrid concrete/metal structure that serves as a reactor vessel well for the SMR reactor, advantageously filled with water, anchoring the SMR to the interior of the reactor building, and advantageously contributing to the third confinement barrier, and all this with minimum modification of the infrastructure of the reactor building.

A hybrid structure according to the invention to some degree serves as the reactor vessel well of an integrated SMR reactor, and therefore has the following functions:
a function of solidly anchoring it to the existing civil engineering infrastructure (raft, shell and intermediate floors) of the PWR reactor, in order to comply with the requirements of earthquake resistance,
a sealing function provided by its metal double-skin that makes possible:
   placement in water and biological protection,
   providing through-connections to the main pool above the existing reactor vessel well of the PWR reactor and connection thereof to the existing fuel handling system,
   placement of an entire integrated SMR reactor into a uniform volume of water that is defined by the internal volume of the hybrid structure, contributing to the function of safe evacuation of residual power,
a contribution to the nuclear material confinement safety function: with closure by a removable lid on the top of the hybrid structure, the integrated SMR reactor that is housed and retained therein is located in an enclosure taking on some or all of the requirements linked to the nuclear material confinement guaranteed safety function (third barrier),
advantageously, a constructability function because a hybrid structure may be produced from prefabricated modules, which makes possible:
   a modularity that guarantees insertion module by module in the reactor building like an integrated SMR reactor makes it possible to adapt the points of anchorage and of connection to the existing civil engineering structures to ensure that forces are absorbed and to adapt to all PWR reactor configurations,
   assembly by welding that guarantees great flexibility in respect of the assembly conditions, a small footprint and sealing for the contribution to the confinement function,
   absence of shuttering as such and shuttering supports that makes possible optimum insertion in the existing infrastructure limits the impact of the retrofit in accordance with the invention to just what is needed and optimizes the duration of the site.

In fact, the method according to the invention is to some degree a break with all the envisaged dismantling methods.

In substance, compared to a plan for dismantling a PWR as envisaged in [3], the invention is distinguished by the fact that:
no building is demolished, whether it is a building of the nuclear island (reactor building, fuel building or auxiliaries building) or the conventional island (machine room),
the reactor vessel is not removed from the reactor building,
no rehabilitation of the site proper has to be carried out.

In other words, the inventor has overcome a universal prejudice of experts in the nuclear field whereby the complete dismantling of a nuclear power plant must be carried out to the point of destruction of all the buildings and rehabilitation of the site whereas the technical reality is that only a few non-replaceable components of the primary circuit of the reactor have reached the end of their statutory operating life.

Also, even if accompanied by a reduction of power, the retrofit method according to the invention makes it possible to impart a second operating phase to a 900/1300 MWe pressurized water reactor (PWR) nuclear power plant by replacing the PWR reactor and its three or four steam generators with integrated SMR reactors.

An SCOR 200 integrated SMR reactor can typically be designed to deliver 200 MWe. Also, replacing a 900 MWe PWR reactor with three SCOR type SMR reactors would result in a power plant the power of which in the second operating phase would be equal to 3×200/900=67% of its initial power, i.e. a power reduction of 33%. For a 1300 MWe PWR reactor the reduction in power would be 38%. Another evaluation of the power with an integrated SMR reactor planned in the NUWARD™ project would yield an equivalent order of magnitude.

In the end, the retrofit method according to the invention has numerous advantages of which there may be cited:
The reduction of the initial investment in a nuclear power plant through the reuse of a great deal of the equipment, virtually all of the conventional island and part of the nuclear island, including in particular the civil engineering structures. Over and above partial dismantling according to the invention, only refurbishing of the machine room is necessary to adapt to the dimensions of the equipment of the energy conversion cycle to suit the reduction of power linked to the retrofit.
The lack of the need to find a new nuclear site, which implies a great reduction of the environmental and financial impact, with the continuity of the local, economic and social environment, around different existing nuclear sites the power plants of which would be transformed by the retrofit method. Furthermore, from a societal point of view, the acceptability of existing nuclear sites may be considered as achieved, and it is probable that the same applies to retrofitting those sites.
The great reduction of construction time: the transformation of a nuclear power plant using the invention is carried out in accordance with an optimized modus operandi, with many operations prepared beforehand off-site, which makes it possible to render parallel at least some of the time periods, such as the production of prefabricated modules of the hybrid structures.
The great reduction of waste: by using a maximum amount of building/equipment of the power plant for a second operating phase, the quantity of waste generated, including waste with an exceptionally low level of nuclear activity, is greatly reduced.
Modularity of the nuclear part of the energy mix: the reduced power and modularity in time achieved by the number of reactors to be converted in accordance with the invention and their positioning in the territory, in particular in the case of the French installed base, makes it possible to plan on a dynamic timescale the nuclear part required in the energy mix.
An improvement to the reputation of nuclear energy because with the retrofit in accordance with the invention this form of energy becomes durable: circular economy of materials and equipment, obsolescence, . . .
A reduction of the carbon balance of nuclear energy, the greater part of which is linked to the construction of the installations. By increasing the time of operation of an installation (nuclear power plant) the carbon balance relative to the MWe effectively produced is reduced.

Other advantages and features of the invention will emerge more clearly from a reading of the detailed description of embodiments of the invention given by way of non-limiting illustration with reference to the following figures.

### BRIEF DESCRIPTION OF THE DRAWINGS

FIG. 1 depicts in histogram form the temporary evolution of the number of nuclear reactors commissioned and decommissioned worldwide according to publication [1].

FIGS. 2A, 2B, 2C are schematic perspective and part-sectional views of various configurations of an existing PWR type nuclear reactor.

FIG. 3 is a schematic view of a prior art PWR type nuclear reactor primary circuit in a configuration with three primary loops.

FIG. 4 is a schematic view of three cycles of a prior art PWR type nuclear reactor.

FIGS. 5A to 5D depict the various steps of the planned dismantling of a PWR nuclear reactor as described in publication [2].

FIGS. 6, 6A, 6B are schematic views respectively in perspective and as if by transparency, in perspective and in section, and from above of a hybrid structure according to the invention in which is housed an integrated SMR reactor using the SCOR integrated SMR design to illustrate the example.

FIG. 7 is a schematic view from above depicting a hybrid structure according to the invention with an integrated SMR reactor using the SCOR design used for the illustrative example the removable upper compartment of which has been removed from its fixed compartment, the two compartments being accommodated alongside each other in the hybrid structure.

FIG. 8 is a perspective view as if by transparency depicting a variant of a hybrid structure according to the invention that includes a removable upper closure lid closing said structure above the integrated SMR reactor.

FIG. 9 is a perspective view in cross section showing the interior of the metal part of a hybrid structure according to the invention.

FIG. 10 is a perspective view in cross section showing the interior of the metal part of a variant of a hybrid structure according to the invention consisting of prefabricated modules.

FIG. 11 is a view of a steam generator as installed in 900/1300 MWe PWR type power plants of the electronuclear installed base of pressurized water reactors (PWR).

FIG. 12 is a perspective view partly in section of another integrated SMR project, namely the SCOR project, in a configuration with the removable compartment fixed onto the top of the fixed compartment.

FIG. 13 is a schematic view depicting the physical possibility of integrating three hybrid structures according to the invention instead and in place of the pumps and the steam generator of the existing PWR nuclear reactor primary circuit.

FIGS. 14A to 14E depict the various steps of a method of retrofitting a nuclear power plant initially including a PWR reactor.

FIG. 15 is a schematic perspective view in section of a nuclear power plant transformed by the retrofit method according to the invention.

### DETAILED DESCRIPTION

Throughout the present application the terms “vertical”, “lower”, “upper”, “low”, “high”, “below” and “above” are to be understood with reference to a reactor building of a power plant and an integrated SMR nuclear reactor in the vertical operating configuration and arranged in the reactor building using the retrofit method according to the invention.

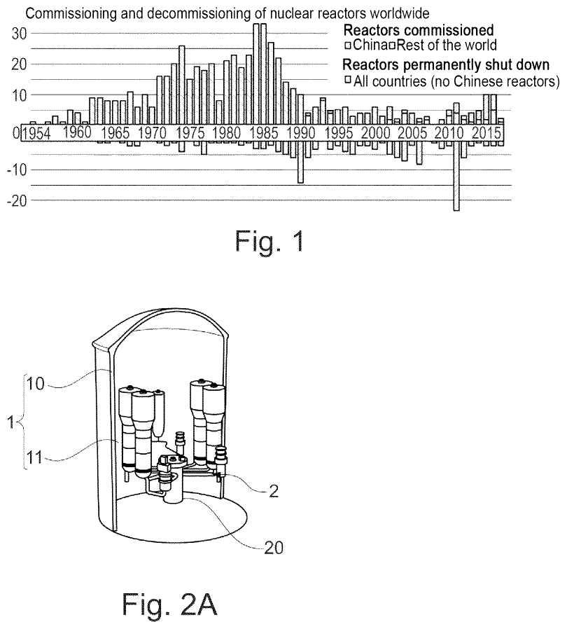

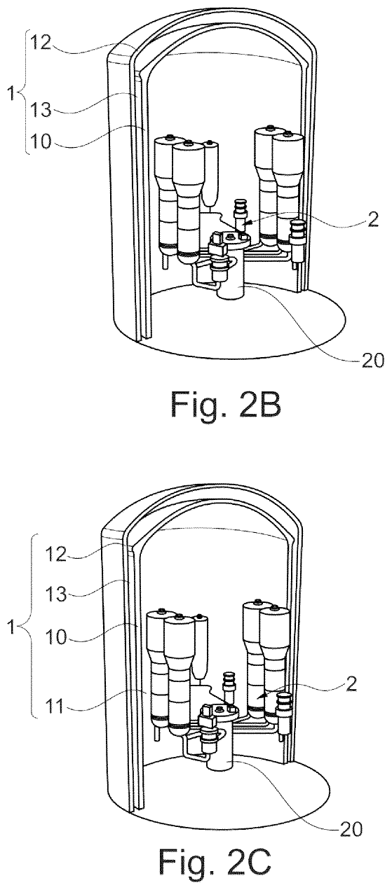

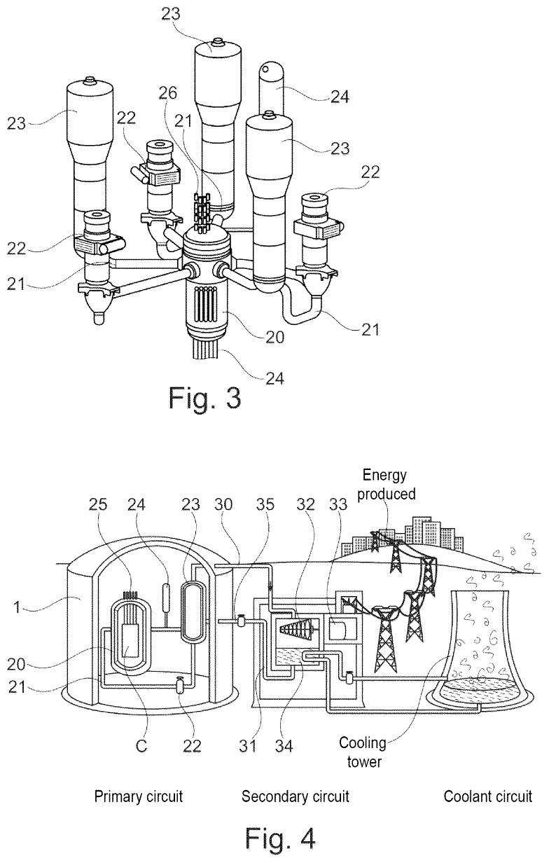

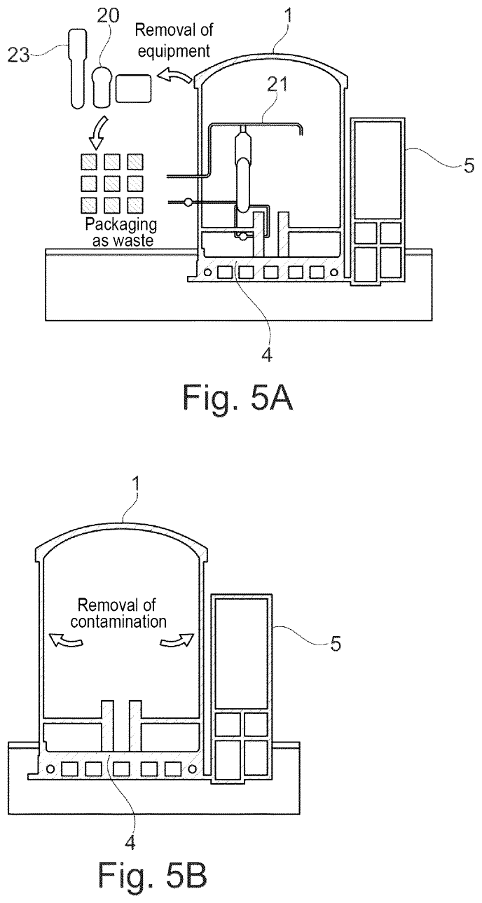

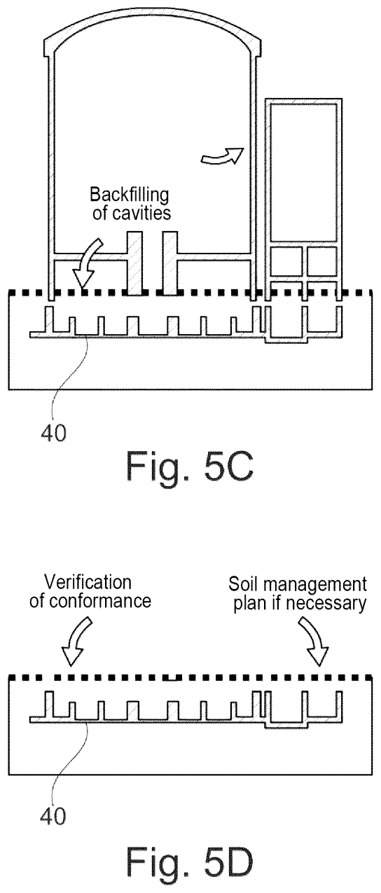

FIGS. 1 to 5D have already been described in detail in the preamble and will therefore not be commented on below.

For reasons of clarity, the same element according to the invention and according to the prior art is designated by the same reference number in all of FIGS. 1 to 15.

The various figures do not represent all of the fluid, electrical and control and command connections or the instrumentation system that will be necessary for the operation of a nuclear power plant that has been transformed by a method according to the invention. In particular, the fluid lines for steam, with the associated pipework, are not mentioned because there is no requirement for first order integration of those lines in the architecture. In particular the steam and water fluid feed lines from and to an integrated SMR reactor that need to pass through the hybrid structure have not been represented.

As a preliminary to the description of the method according to the invention for retrofitting a nuclear plant there are described the essential means employed and the feasibility of integrating those various means into an existing reactor building.

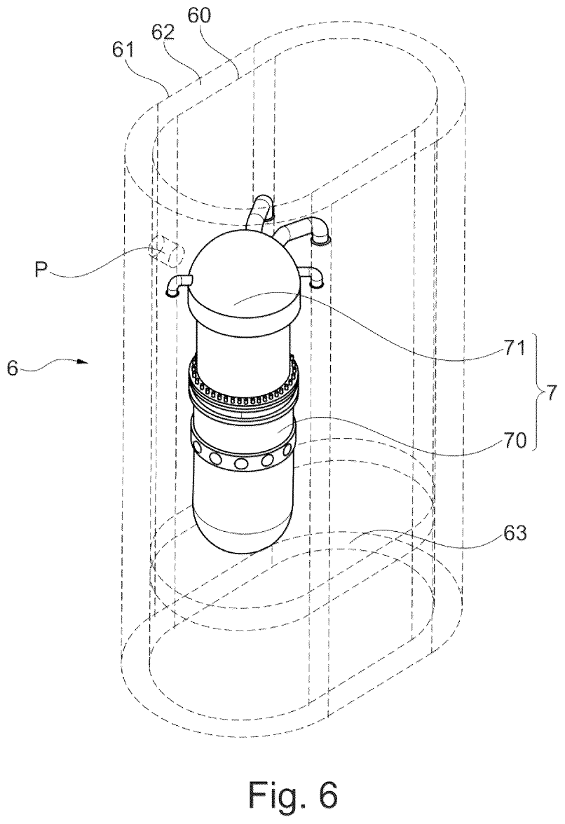

FIGS. 6, 6A and 6B represent a hybrid structure according to the invention, designated overall by the reference 6 and housing within it an integrated SMR reactor designated overall by the reference 7, the whole being intended to be installed instead and in place of a subassembly consisting of a primary pump and a steam generator of an existing PWR reactor primary circuit. In these FIGS. 6, 6A and 6B the SCOR type integrated SMR design has been chosen for representation.

A hybrid structure 6 to some extent serves as a reactor vessel well of an integrated SMR reactor 7 and therefore has for its main functions housing and supporting such a reactor, the civil engineering functions (anchorage, strength, seal, constructability) associated therewith and the advantageous possibility of being able to store under water the removable compartment 71 of the integrated SMR reactor 7 for the phases of handling the fuel or maintenance of what is inside the fixed compartment 70 of the SMR.

A hybrid structure 6 consists of a metal double skin, i.e. two metal walls 60, 61 spaced from each other, the space between these two walls 60, 61 being filled with concrete 62.

A supporting floor 63 is arranged substantially horizontally as a bottom inside the internal wall 61 to support the integrated SMR reactor 7.

The sealed interior volume of the hybrid structure 6 is therefore delimited by the internal wall 61 and the bottom 63. It is intended to be filled with water to serve as a biological barrier and depending on the configuration of the integrated SMR 6 it contributes to the function of evacuation of residual power from the SMR.

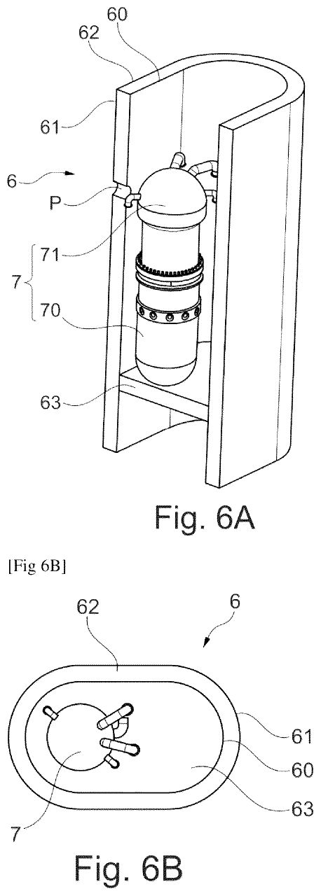

Furthermore, as FIG. 7 shows the structure 6 is sized so that this interior volume can be housed under water on the side of the fixed compartment 70 of the integrated SMR reactor 7, with the removable compartment 71 removed from the top of the fixed compartment 70. This makes it possible to carry out fuel handling and/or maintenance operations on the fixed compartment 70 in safety because the two compartments 70, 71 are in a uniform volume of water. The removable compartment 71 is handled by the large component handling equipment used for the insertion of the integrated SMR 7.

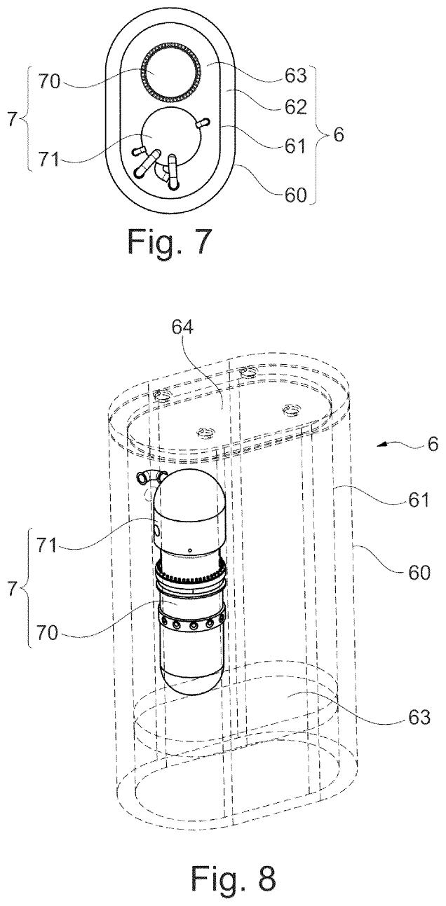

As shown in FIG. 8 the hybrid structure 6 is preferably provided with a metal lid 64 removably connected in sealed manner to one and/or the other of the metal walls 60, 61 of the hybrid structure. When this lid 64 is in the installed configuration the structure 6 itself constitutes a contribution to the safety controlled confinement of the nuclear materials, the first consisting of the metal sheath that envelopes the fuel in the integrated SMR reactor 7, the second consisting of the casing that constitutes the reactor vessel of the integrated SMR reactor 7.

Furthermore, the hybrid structure 6 has an opening P passing through it. As described in detail below, this opening P is intended to be connected to a pipe for the transfer of fuel assemblies from and to the interior of the SMR reactor 7.

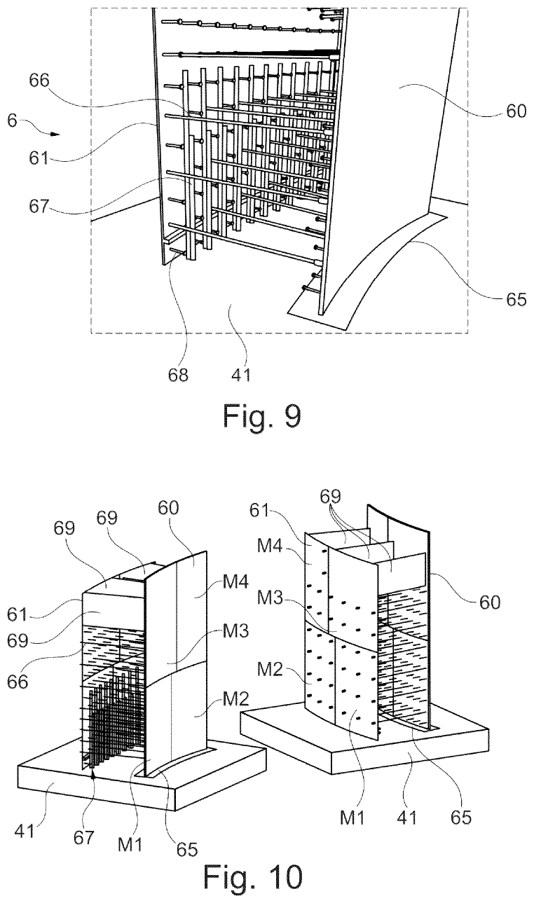

As represented in more detail in FIG. 9 the hybrid structure 6 comprises first of all a metal anchor plate 65 that is fixed to the raft 41 of the reactor building, which makes it possible to anchor the hybrid structure 6 to the existing infrastructure 4 of the reactor building 1. In the example depicted this anchor plate 65 is welded to the interior metal wall 60. There may obviously be envisaged another anchor plate welded to the exterior metal wall 61 in addition to the plate 65 welded to the interior metal wall 60. The connection to the raft 41 may be provided using various specific civil engineering techniques and depending on the strength requirements obtained from structural studies, in particular for the loads under earthquake conditions.

In the space 62 inside the metal double skin retaining bars are welded to and between the walls 60, 61 to maintain the spacing between them.

To reinforce the concrete in the space 62 reinforcing bars 67 are welded to metal studs 66, 68 welded to one and/or the other of the metal walls 60, 61.

Furthermore, although not represented, other plates may be welded to one and/or the other of the metal walls 60, 61, in particular:
to serve as a support for the bottom 63 intended to serve as a support for the integrated SMR reactor 7,
to support the pipes and other auxiliary items necessary for the operation of the integrated SMR reactor 7,
to connect the hybrid structure 6 to the intermediate floors 42 and shells 43 of the existing infrastructure 4 of the reactor building 1 so as mechanically to reinforce the whole and to achieve an overall strength of the structure at least equivalent to that before implementing the hybrid structure 6.

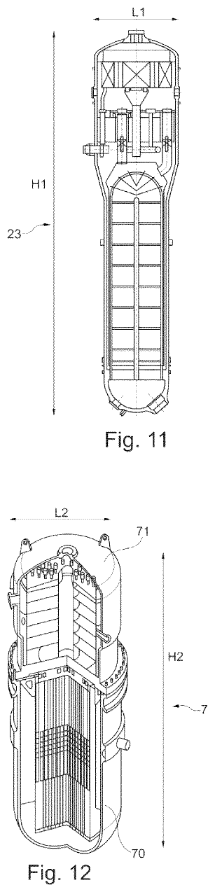

FIG. 10 shows a variant of a hybrid structure 6 made up of modules M1, M2, M3, M4 that are prefabricated off-site and then assembled on-site, that is to say inside the reactor building 1. In this variant the structure 6 may include mechanical stiffeners 69 arranged in the upper part of the structure. This variant is advantageous because, depending on the type of reactor building 1 and its existing entry airlock initially designed for replacing the steam generators 23, the size of each module can be adapted so as to have the greatest dimension that it will be possible to insert via the entry airlock. This further optimizes the time and the cost of the retrofit according to the invention. Hybrid structures have already been introduced for nuclear installations internationally and projects are currently being approved for France: see [4].

Although this is not imperative, the retrofit method according to the invention, as described in detail hereinafter, is advantageously carried out when all components involved in the transformation have been handled with no or minimal impact on the infrastructure 4 of the reactor building 1.

The inventor has analyzed that this implies the ability to remove all the components (primary pumps 22, steam generators 23 and pressurizer 24) of the primary circuit of the existing PWR reactor via the airlock provided for this purpose and in the modification phase to insert all the bulkiest components (hybrid structures 6, integrated SMR reactors 7) of the new primary circuit via the same airlock.

The possibility of handling the structures 6 before pouring the concrete in them has been demonstrated by the foregoing.

The inventor has therefore also verified beforehand that integrated SMR reactors 7 could also be handled in a single block, i.e. once completely assembled, via the same handling path, i.e. via the entry airlock of the reactor building.

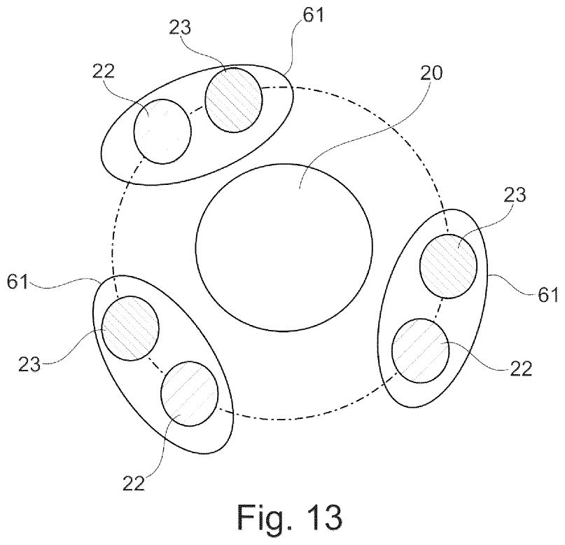

FIG. 11 relates to an existing steam generator 23 in a PWR reactor. The overall dimensions H1*L1 of this kind of steam generator 23, with dimensions of the order of 22 m high by 5 m wide, enable it to be inserted through an existing entry airlock of the reactor building 10 in order to replace it.

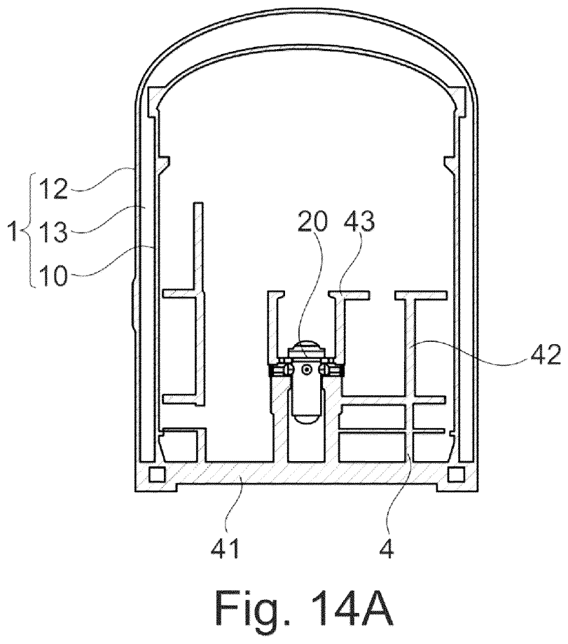

FIG. 12 shows an integrated SMR reactor 7 of the SCOR project: its overall dimensions H2*L2 are less than those H1*L1 of a steam generator 23.

The maximum overall dimensions less than 22 m*5 m for this example of integrated SMR reactor 7 projects therefore enable it to be inserted via the entry airlock in the reactor building 1 by the handling systems for the steam generator 23, as designed at the outset. The handling system providing horizontal positioning and then tilting to the vertical is also compatible with this example. Likewise, its mass is compatible with the load capacities of the equipment of the handling system.

Consequently, the insertion of an integrated SMR reactor into the reactor building 1 without impacting its infrastructure 4 is achieved.

The inventor then considered the optimum placement that the hybrid structure 6 should have with the integrated SMR reactor 7 in the reactor building 1.

To optimize the layout and the costs of the retrofit method the inventor has adopted the following integration criteria:
limited impact on the infrastructure 4 anchoring the integrated SMR reactors 7,
maximum re-use of the elements of the existing infrastructure: functionalities of the various barriers, biological protection, . . . ,
functional integration of the integrated SMR reactors with optimized connections to the two existing functional systems, namely that dedicated to fuel handling and that dedicated to the evacuation of power to the machine room.

Based on the above criteria, the layout of the integrated SMR reactors was arrived at through three-dimensional critical path analysis.

The inventor concluded that the optimum positioning was:
in height (z), in accordance with an alignment of the fuel handling/biological protection system,
in the (x, y) plane as seen from above, instead and in place of the steam generators 23 with axial symmetry.

In addition to these two positioning parameters the inventor analyzed that the phase of operation of an integrated SMR reactor would further necessitate additional room for the removable compartment 71 that must be removed from its fixed compartment 70 for loading/offloading fuel and/or maintenance of internal components.

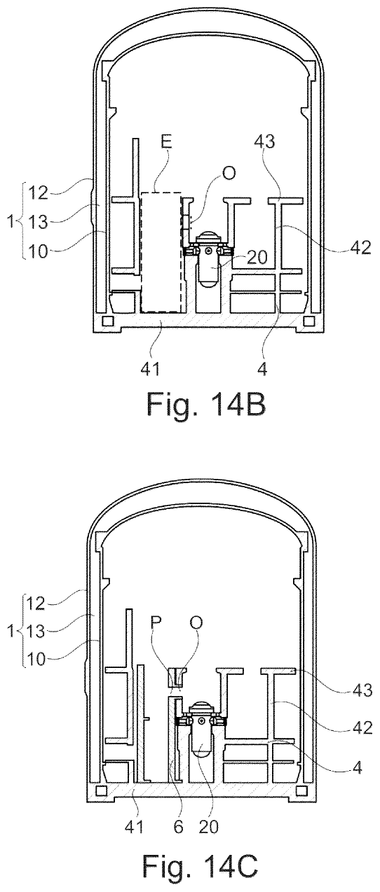

With a transformed nuclear power plant with 3 or 4 integrated SMR reactors it is preferable to be able to consider equally the layout of the removable compartments 71 and the reactors. By analyzing the spatial configuration of the primary circuit of a PWR such as it exists the inventor found this optimum layout. In fact, on each primary loop 21 the primary pump 22 is spatially back-to-back with the steam generator 23 with which it is associated. Thus if an integrated SMR reactor 7 is installed instead and in place of a steam generator 23 it is possible to reserve the space occupied by the primary pumps 22 by the removable compartments 71. This optimum configuration is schematically represented in FIG. 13: in the end it enables allocation to each SMR of a location dedicated to its removable upper part and makes it possible to be able to consider an installation operation configuration requiring simultaneous opening of all the SMR.

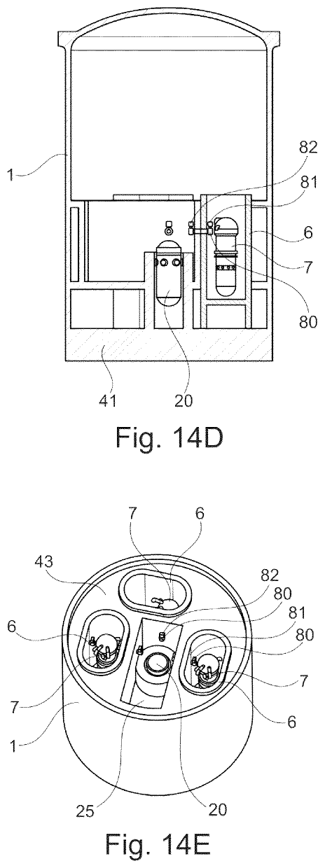

There are described next with reference to FIGS. 14A to 14E the various steps of the method according to the invention for retrofitting an existing PWR reactor nuclear power plant taking into account the analyses mentioned hereinabove. Step a/: the PWR reactor is shut down.

This first step aims to enable the retrofit power plant site configuration.
All the fuel assemblies present in the reactor vessel 20 are evacuated to the outside of the reactor building 1. The primary circuit 1 is then drained completely.

Safety analyses preceding opening of the site may indicate whether the fuel assemblies can remain in the pools of the fuel building for the duration of the site. In this case the retrofit site (steps b/ and c/) could be opened without waiting for the fuel assemblies to have a residual power compatible with the rules for transportation of nuclear materials and thus to save time in complete planning of the operation.

Step b/: partial electromechanical dismantling of the PWR reactor is carried out. The components of the primary circuit 2 are therefore dismantled and evacuated to the exterior of the reactor building 1, preferably in the following successive substeps:
b1/ dismantling of the primary lines 21 arranged between steam generators 23 and the reactor vessel 20,
b2/ dismantling and evacuation of the steam generators 23,
b3/ dismantling and evacuation of the primary pumps 22,
b4/ dismantling and evacuation of the pressurizer 24,
b5/ dismantling of the primary lines 21 initially at the outlet of the steam generators 23 as far as the passage through the shell of the reactor building.

Only the reactor vessel 20 is left in place in the reactor building 1 (FIG. 14A). In fact, leaving the reactor vessel 20 in place does not impede achieving the retrofit installation configuration. Furthermore, the inventor is of the opinion that, by leaving the reactor vessel in place during the phase of operating the nuclear power plant once retrofitted with the integrated SMR reactors, the activation materials, in particular Co⁶⁰, will have time to decrease.

On the other hand, all material is removed from the interior of the nuclear reactor vessel 20 after which the latter is neutralized.

To this end the following sub-steps are executed:
b6/ sealed blocking of the hydraulic connections of the reactor vessel, possibly by placing a solid plug in each hydraulic connection followed by sealed welding of the plug, the welds preferably being verified by gamma graphics,
b7/ closing the reactor vessel by refitting its lid with all the passages for the control rods plugged beforehand and fitting a radioprotection cover if necessary,
b8/ filling the reactor vessel with water or inert gas by means of a connection and pressure control and/or liquid level device; the filling and liquid level control device will be positioned inside the reactor building; it may in particular be connected to the reactor vessel by using again one or more of the passages through the lid to provide the fluid connection.

If necessary the lid of the reactor vessel 20 can undergo modifications, in particular to perfect its seal and/or to enable optimization of the neutralization of the reactor vessel.

After the neutralization of the reactor vessel 20, if necessary, the interior of the reactor building 1 is decontaminated to eliminate any radioactive contamination that may have been deposited.

Given radioprotection considerations, steps a/and b/are carried out by human intervention or remotely.

Step c/: the hybrid structures 6 are installed.

Prior to this step c/strength studies may be carried out, in particular of the earthquake proofing of the nuclear island in its overall configuration to define all the connections of the infrastructure 4 of the reactor building 1 with the hybrid structures 6, the dimensions of the hybrid structures 6, typically the thickness of the plates for the walls 60, 61, the density and the dimensions and the studs and connecting rods between the walls 60, 61, the methods of anchoring to the raft 41 and the connection with the floors 43 and shells 42 connected to the hybrid structures 6.

This step c/ includes cutting up and evacuating parts of the shells 42 and/or the floors 43 and where necessary of the raft 41 of the infrastructure 4 of the reactor building 1.

This enables preparation for the curing of the hybrid structures 6 and providing all the devices for anchoring them to the infrastructure 4.

Furthermore, step c/ consists in producing openings in the shells 42 leading to the existing underlying pool of the reactor for the connection to the fuel handling system. The core drilling technique will advantageously be used for this operation.

FIG. 14C shows:
the space E it is necessary to open up for the installation of a hybrid structure 6,
the circular opening O leading to the pool above the reactor vessel 20.

All the cutting operations can be carried out using concrete sawing devices already widely used in nuclear practice. Operations to prepare the existing infrastructure 4 could be carried out.

Once these operations of cutting up and evacuating the cut up parts of the infrastructure have been effected the hybrid structures consisting of prefabricated modules enter via the entry airlock of the reactor building 1. Modules can typically be introduced in the form of horizontal tranches with a unit height of 5 meters.

This is followed by the placement proper of the hybrid structures 6. This placement is accompanied by anchoring thereof to the infrastructure 4 of the reactor building 1. In particular each hybrid structure 6 is fixed to the raft 41 by means of a fixing plate 65. The prefabricated modules are welded together and anchor connections are made to the shells 42 and the floors 43. Furthermore, the seal to the underlying compartment of the reactor vessel 20 is made.

Once each fixing device of a hybrid structure 6 has been placed and fixed in place a metal horizontal connecting pipe 80 is installed between each hybrid structure and the reactor vessel well 20, preferably by sealed welding thereof to the two metal walls 60, 61 of the double casing. On the side of the pool above the reactor vessel 20, to guarantee the seal of the pipe 80, the latter is welded to the liner of the pool. This pipe 80 is a transfer pipe in which a fuel assembly can be handled by means of the handling system.

Step d/: an integrated SMR nuclear reactor 7 is placed in and retained in each hybrid structure 6 installed in step c/.

As specified hereinabove, the integrated SMR reactor 7 is arranged in a position in which it is accessible by the existing fuel handling system.

Each integrated SMR reactor 6, initially manufactured off-site, is introduced into the reactor building by means of the existing handling system and positioned directly on the bottom 63 of the hybrid structure 6 provided for this purpose.

Finally, isolating valves 81, 82 are installed at the ends of each pipe 80 (FIGS. 14D, 14E).

Step e/: there then follow the fluid and/or electric connections of each integrated SMR reactor 7 to the control room and to the machine room.

The auxiliary circuits are installed and the fluid and/or electric connections to the nuclear auxiliaries building are made.

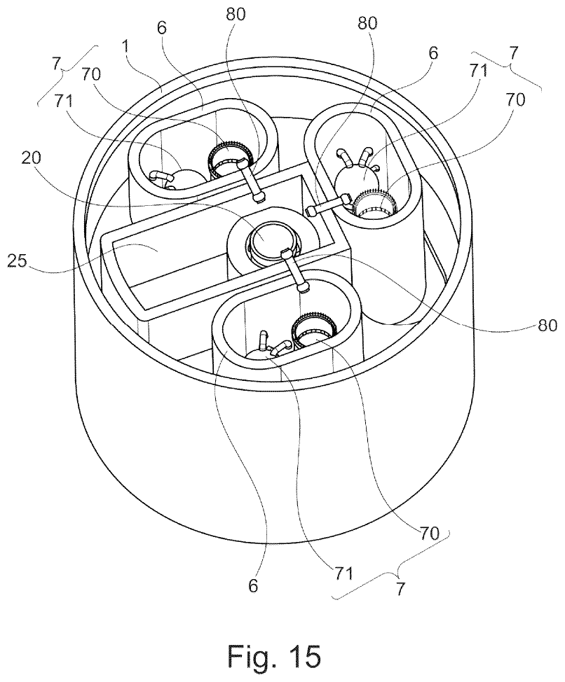

FIG. 15 depicts the interior architecture of a reactor building 1 of an initial PWR reactor power plant after it has been converted using the retrofit method of the invention with three hybrid structures 6 each housing and supporting an integrated SMR reactor 7.

The invention is not limited to the examples that have just been described in particular features of the examples depicted may be combined with one another in variants that are not depicted.

Other variants and embodiments can be envisaged without this departing from the scope of the invention.

Although in the example depicted the hybrid structures have been sized to optimize the integration of the integrated SMR reactors 7 and their removable compartment 71 during operation there may also be envisaged smaller dimensions for the hybrid structures, that is to say a mutualized layout solution for all the removable compartments 71 once their respective fixed compartments 70 have been removed.

In the context of the invention there may envisaged handling the removable compartment of an integrated SMR reactor at the bottom of a hybrid structure or at least alongside and under the same water as the fixed compartment of the SMR.

In the example depicted the means of transfer from an integrated SMR reactor 7 to the pool above the reactor vessel 20 is limited to a single pipe 80 so as to be able to isolate by means of the valves 81, 82 the various volumes of water (interior volume of the hybrid structure 6, pool above the reactor vessel 20). This choice necessitates horizontal transfer of a fuel assembly and therefore provision of a vertical/horizontal tilting device since once the fuel assembly has been extracted vertically from the interior of the integrated SMR reactor 7 it must be introduced horizontally into the pipe 80. This horizontal position may be maintained until exit from the reactor building 1 because it is in this position that the assembly passes to the fuel building.

A variant may consist in replacing the transfer pipes 80 by a free surface water channel, possibly equipped with a cofferdam to isolate the volume of water. The cofferdam has the function of a valve in the sense that it enables hydraulic isolation between the two compartments that it separates. A device of this kind makes it possible to dispense with a horizontal/vertical tilting device.

The example of the retrofit method depicted relates to a PWR reactor. A method of this kind may equally serve as the basis of a method of retrofitting a BWR reactor, subject to adaptations linked to the particular configuration of that type of reactor compared to a PWR, these modifications being clear to a person skilled in the art of nuclear reactors.

LIST OF REFERENCES CITED
[1]: https://www.worldnuclearreport.org/IMG/pdf/20170912wnisr2017-en-Ir.pdf (World Nuclear Industry Status Report 2017).
[2]: http://www.centrale-energie.fr/spip/IMG/pdf/20200115_centrale_energies_final.pdf
[3]: https://www.edf.fr/sites/default/files/contrib/groupe-edf/producteur-industriel/nucleaire/Notes% 20d%27information/dem_fessenheim_p3.pdf
[4]: https://csti-groupe.com/2019/01/07/:
[5]Zrodnikov et al. “Nuclear power development in market conditions with use of multi-purpose modular fast reactors SVBR-75/100”, Nuclear Engineering and Design, Amsterdam, Vol.235, N°14-16, 1^{st} August 206, pages 1490-1502.
[6]: Dragunov Yu G et al. “Project of SVBR-75/100 reactor plant with improved safety for nuclear sources of small and medium power”, 5^{th} International Conference on Nuclear Option in Countries with Small and Medium Electricity Grids, Dubrovnik, 16 May 2014, pages 1-13, XP09003576.
[7]: Zrodnikov AV et al: “Renovation of the “Old” NPP units as an Economically Effective Way of Nuclear Power Development”, Proceedings of GLOBAL 2005 Tsukuba, 9 Oct. 2005, pages 1-6, XP09003571.

1. A method of retrofitting a nuclear power plant initially comprising at least one light-water nuclear reactor (LWR), including a reactor building housing a reactor vessel, a primary circuit and a reactor pool, a fuel building, a nuclear fuel handling system for feeding nuclear fuel assemblies from the fuel building to the reactor building, inside the reactor vessel, and vice versa, a machine room, a control room and a nuclear auxiliaries building, the method including the following steps for each reactor:
a/ shutting down the reactor including evacuation to the exterior of the reactor building of all the fuel assemblies present in the reactor vessel (and complete draining of the primary circuit,
b/ partial electromechanical dismantling of the reactor including removal and evacuation to the exterior of the reactor building of the components of the primary circuit with the exception of the reactor vessel of the reactor left in place in the reactor building, the removal of all material from the interior of the nuclear reactor vessel followed by neutralization of the latter,
c/ installation instead and in place of some of the components of the primary circuit evacuated during step a/ of at least one removably closed hybrid structure itself consisting of a metal double skin fast and concrete poured into the space between the two metal walls constituting the double skin,
d/ placing and retaining in the interior of each hybrid structure installed in step c/ at least one nuclear reactor, termed an integrated small modular reactor (SMR), the integrated SMR reactor(s) being arranged in a position accessible by the fuel handling system.

2. The retrofit method as claimed in claim 1 including after step d/ a step e/ of fluid and/or electrical connection of each reactor to the control room and to the machine room, placement of the auxiliary circuits, and fluid and/or electrical connection to the nuclear auxiliaries building.

3. The retrofit method as claimed in claim 1, installation in step c/ and placement in step d/ including respective passage of each hybrid structure in the form of prefabricated modules and each integrated SMR reactor via the same access airlock to the exterior from the reactor building by which the whole of each component is evacuated in step b/.

4. The retrofit method as claimed in claim 1, the dismantling and evacuation in step b/including the following successive sub-steps:
b1/ dismantling of the primary lines arranged between steam generators and the reactor vessel,
b2/ dismantling and evacuation of the steam generators,
b3/ dismantling and evacuation of the primary pumps,
b4/ dismantling and evacuation of the pressurizer,
b5/ dismantling of the primary lines initially at the outlet of the steam generators as far as passing through the shell of the reactor building.

5. The retrofit method as claimed in claim 1, the neutralization of the reactor vessel in step b/including the following successive sub-steps:
b6 /sealed blocking of the hydraulic connections of the reactor vessel,
b7/ closing the reactor vessel by replacing its lid and if necessary fitting a radioprotection cover,
b8/ filling the reactor vessel with water or inert gas by means of a connecting and level or pressure monitoring device.

6. The retrofit method as claimed in claim 5, step b6/ consisting in placing in each hydraulic connection a solid plug followed by sealed welding of the plug, the welds preferably being verified by gamma graphics.

7. The retrofit method as claimed in claim 1, step b/ including after neutralization of the reactor vessel a step of decontaminating the reactor building to eliminate any radioactive contamination deposited in the interior of said building.

8. The retrofit method as claimed in claim 1, step c/ including cutting and evacuation of parts of the shells and/or the floors and if necessary the raft of the infrastructure of the reactor building that initially support the components of the primary circuit.

9. The retrofit method as claimed in claim 1, step c/ including fixing each hybrid structure to the raft of the infrastructure of the reactor building.

10. The retrofit method as claimed in claim 1, step c/ including after positioning the hybrid structure(s) on and where necessary fixing it or them to the raft the following successive sub-steps:
cutting up and evacuation of the shell part separating the reactor vessel well of the LWR reactor forming part of the reactor pool of each hybrid structure,
installing a horizontal connecting pipe between each hybrid structure and the reactor vessel well.

11. The retrofit method as claimed in claim 10 including after placement and retention of the integrated SMR reactor in step d/ placement of at least one isolating valve on the pipe, preferably two isolating valves, one on the hybrid structure side and the other on the reactor vessel well side.

12. A nuclear power plant obtained by the retrofit method as claimed in claim 1 including:
a reactor building housing a neutralized LWR reactor vessel and a reactor tool,
a nuclear fuel handling system for feeding nuclear fuel assemblies from the fuel building to the reactor vessel inside the reactor building, and vice versa,
at least one, preferably three or four, hybrid structure(s) arranged around the neutralized reactor vessel, each hybrid structure housing an integrated SMR reactor, a fuel building, each integrated SMR reactor being arranged in a position accessible by the fuel handling system.

13. The nuclear power plant as claimed in claim 12 further including a horizontal connecting pipe between each hybrid structure and the reactor vessel well and at least one isolating valve on the pipe, preferably two isolating valves, one on the hybrid structure side and the other on the reactor vessel well side, the fuel handling system including at least one device for tilting fuel assemblies from the horizontal to the vertical one by one to enable transfer thereof via the connecting pipe.

14. The nuclear power plant as claimed in claim 12, each hybrid structure including a bottom configured to support an integrated SMR reactor.

15. The nuclear power plant as claimed in claim 12, each hybrid structure being filled at least in part with water.

16. The nuclear power plant as claimed in claim 12, each hybrid structure being configured to contain the fixed compartment of the SMR reactor and the removable compartment of the latter when it is removed from the fixed compartment.

17. The nuclear power plant as claimed in claim 12, each hybrid structure being provided with a removable lid contributing to the nuclear materials confinement control safety function.
